(19) United States
(12) Patent Application Publication
(10) Pub. No.: US 2004/0244216 A1
(43) Pub. Date: Dec. 9, 2004

(54) Drying system for personal hydration systems

(75) Inventor: Gavin H. Poole, Slidell, LA (US)

Correspondence Address: Gavin H. Poole, 3701 Brookwood Drive, Slidell, LA, 70458, US

(73) Assignee: Gavin H. Poole, Slidell, LA

(21) Appl. No.: 10/454,127

(22) Filed: Jun. 3, 2003

(51) Int. Cl. F26B 25/00

(52) U.S. Cl. 34/103

(57) ABSTRACT

A drying system for bladder-style personal hydration systems is comprised of an air conduit, a system for forcing air through the conduit, and a method of dispersing the air into the bladder. The bladder from the personal hydration system (such as a CamelBak®) is placed over the conduit, and air is forced into the bladder and the drinking tube to dry it. This would provide a faster and potentially microbiologically safer method of drying the bladder as compared to traditional methods.

The purpose of this invention is to provide a faster, more efficient, and microbiologically safer method to dry the bladder and hose of back or waist mounted personal hydration systems.

### BACKGROUND

Due to the increased popularity of sports, and the need for an easier and more efficient way to remain hydrated, many athletes are using back-mounted and/or waist mounted personal hydration systems, such as the CamelBak® (U.S. Pat. No. 5,060,833) as well as many others. These systems are basically comprised of a plastic bag (or bladder) in which the liquid of choice is contained, and a plastic, rubber or latex hose running from the bag to the mouth of the user, to allow the user to take in fluid easily while doing their strenuous activity.

However, once the system is emptied, the nature of the materials involved and the construction of the systems does not allow for easy drying of the bladder and hose. This allows for the retention of residual water for long periods of time, and therefore the possibility for the growth of potentially harmful microorganisms, such as bacteria and molds. Current drying techniques, consisting of a plastic “hanger” which allows the bladder to hang right-side-up, are crude, and may not adequately dry the bladder and hose in a sufficiently short enough period of time to discourage the growth of microorganisms.

The purpose of the present invention is to provide a faster, more efficient, and microbiologically safer method to dry the bladder and hose of personal hydration systems.

### SUMMARY OF THE INVENTION

The present invention is a system that could be used to provide a faster, more efficient, and microbiologically safer method to dry the “bladder” and tubing of back or waist mounted personal hydration systems popular with many sports, such as biking, hiking, and running. It consists of a tube that goes inside of the bladder through the filling port (i.e., the hole in the bladder that is used to fill it with the liquid of choice), and a forced air system the blows air through the tube into the bladder to dry the bladder. Air is dispersed throughout the bladder by arranging a series of angled holes along the tube, so that jets of air blow into the areas of the bladder that tend to retain water (such as the corners), as well as the hose that leads off the bladder.

One embodiment of the drying system would be a stand-alone system, comprised of a delivery tube, a fan or blower module, and a power regulator. Power for the system could either be supplied by conventional AC or DC power, or from a battery pack. Another embodiment would be comprised of a delivery tube, and an attachment to allow the system to use a conventional hairdryer to provide the forced air for the dryer system. Another embodiment would be comprised of the delivery tube and a compressed gas cylinder (either air or any other gas) that would be regulated as to its flow into the bladder or bladders. Other embodiments are possible, but this disclosure is to just illustrate the a few possible designs, and is not intended to be limiting (for example, it would be a simple matter to upscale the disclosed invention to work with many bladder systems simultaneously). Since modifications of the disclosed embodiments incorporating the spirit and substance of the invention may occur to persons skilled in the art, the invention should be construed to include everything within the scope of the appended claims and equivalents thereof.

### BRIEF DESCRIPTION OF THE DRAWINGS

FIG. 1 is a side view of the stand-alone drying system, with a bladder and hose in position ready to be dried.

FIG. 2 is a view of the system from the bottom of the dryer.

FIG. 3 is a cutaway view of FIG. 1, to show the inner workings of a stand-alone system.

FIG. 4 is one alternative embodiment, where the forced air system is mounted 90 degrees to the outlet tube. This embodiment would allow for usage in smaller spaces.

FIG. 5 is one embodiment, where two bladder/hose systems are dried together.

FIG. 6 is another embodiment, where a household hair dryer provides the forced air.

FIG. 7 shows an alternative method of drying the hose.

### DETAILED DESCRIPTION OF THE DRAWINGS

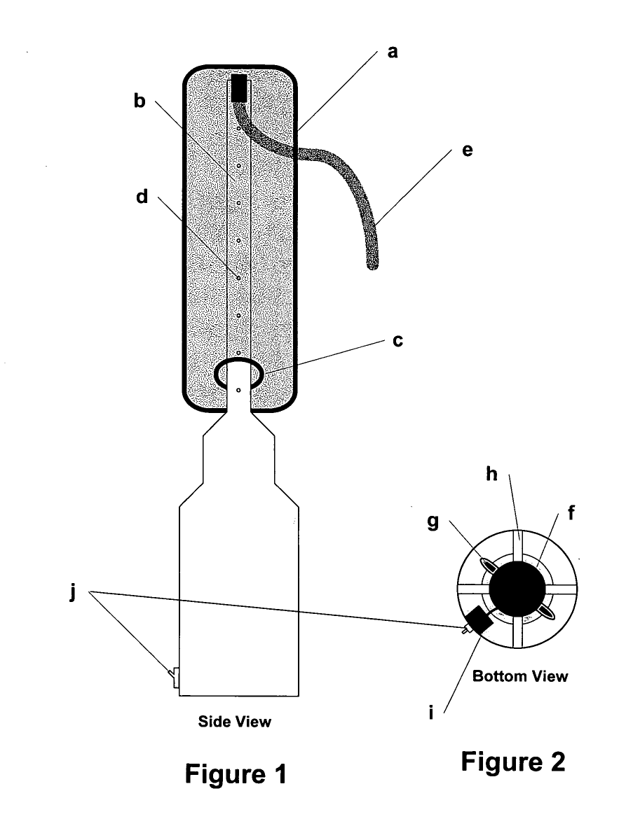

FIG. 1 shows the drying system with a bladder/hose personal hydration system in place for drying. The entire system could be made out of any rigid material, however for obvious reasons a plastic polymer would probably be the most reasonable. The bladder (a) is slid over the drying tube (b) via the refilling port (c) on the bladder. Forced air from the dryer comes out of the drying tube (b) from holes (d) and flows throughout the bladder (a) and hose (e), picking up the residual moisture and leaving the system either through the refilling port (c) or the hose itself (e). The holes (d) are placed and angled in such a way that the airflow is directed into the areas of the bladder (a) that tend to retain water (such as the corners), as well as the hose (e) that leads off the bladder (a).

FIG. 2 shows inside the drying system from the bottom. The main purpose of the dryer is to force air into the bladder (a), and this can be accomplished in a variety of ways. This figure shows one embodiment where an electric motor (f) turns a fan blade (g) in such a way as to pull in air from the outside and force it into the bladder (a). The motor (f) and fan blades (g) are held in the center of the system by a series of brackets (h). The motor can be powered by a number of ways, including (but not limited to) a battery pack (i), AC power, or other energy producing systems. Power for the system is controlled from the outside of the dryer by an on/off style switch (j). Another possible source of flowing gas could be either compressed air, or any other compressed gas.

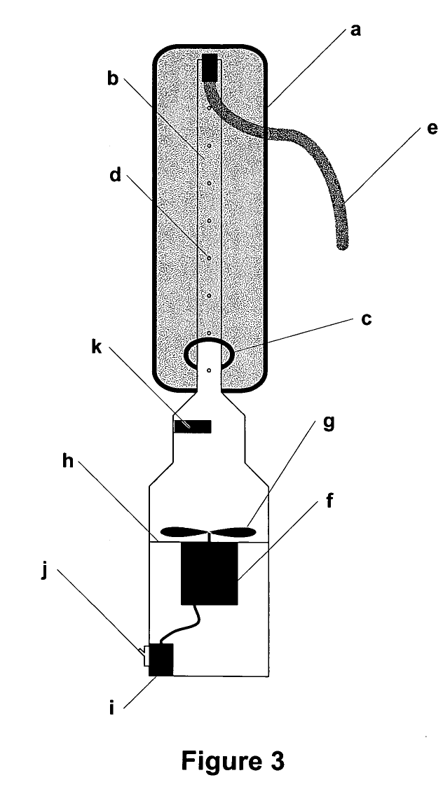

FIG. 3 is a cut away of the dryer system to show how the system works. In this vertical embodiment, the air is drawn from the outside by the motor and fan (f and g, respectively), forced up the drying tube (b) into the bladder and hose (a and e, respectively) of the personal hydration system, and the now moisture laden air leaves the bladder (a) through the refilling port (c) or the hose itself (e). The drying system can also include a heater (k) to dry and heat the air being moved by the motor and fan (f and g, respectively), so that it is more efficient in removing the moisture form the bladder and hose (a and e, respectively).

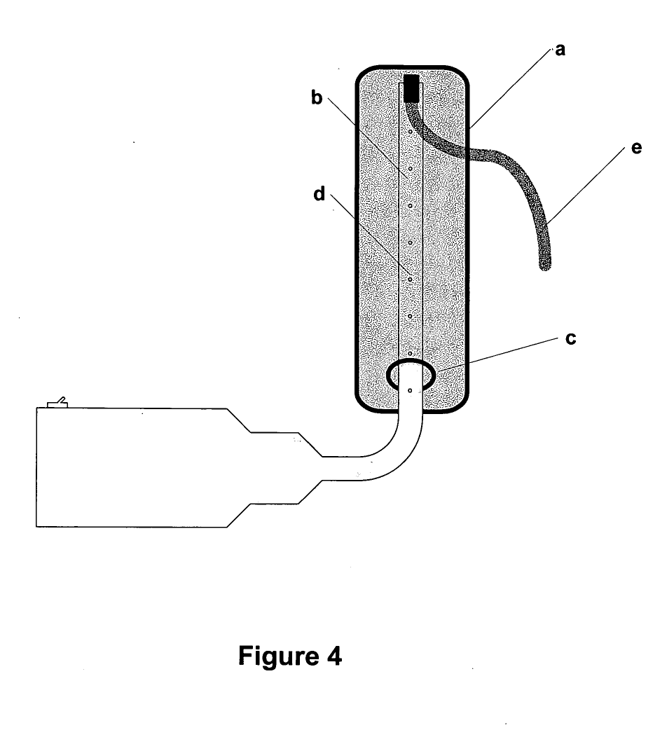

FIG. 4 shows an alternative embodiment, where the dryer tube (b) is at a 90-degree angle from the rest of the drying system. This embodiment would allow for the use of the drying system in situations where there is not much vertical clearance. This also would produce a larger separation between the air intake end of the drying system and the moist air exiting the bladder (a), which would allow for minimal mixing of moist exit air from the dry in-flow air. Taken one step further, another embodiment (not shown) would have the dryer tube 180 degrees from the rest of the drying system. This would produce an even more compact system, and further separate the air intake from the air output.

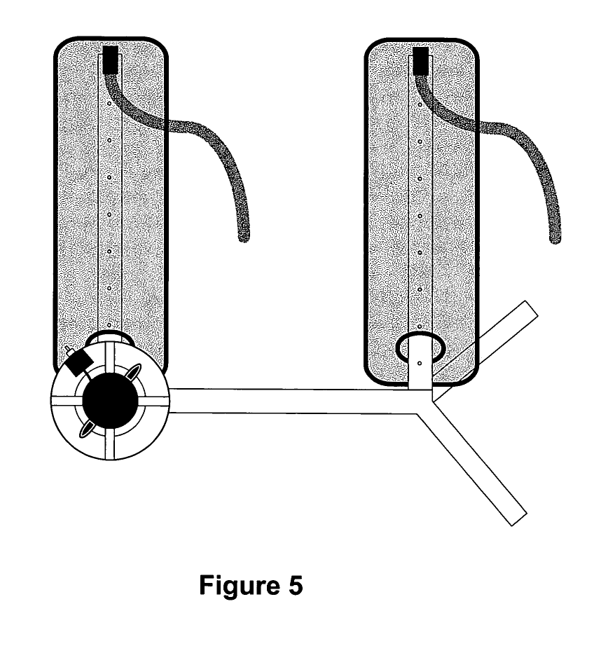

FIG. 5 is another embodiment, where 2 personal hydration systems are being dried simultaneously. The principle of the system is the same as above, but a higher flow of air would be necessary. This idea could also be expanded to cover as many drying stations as needed, provided an adequate air introduction system was attached.

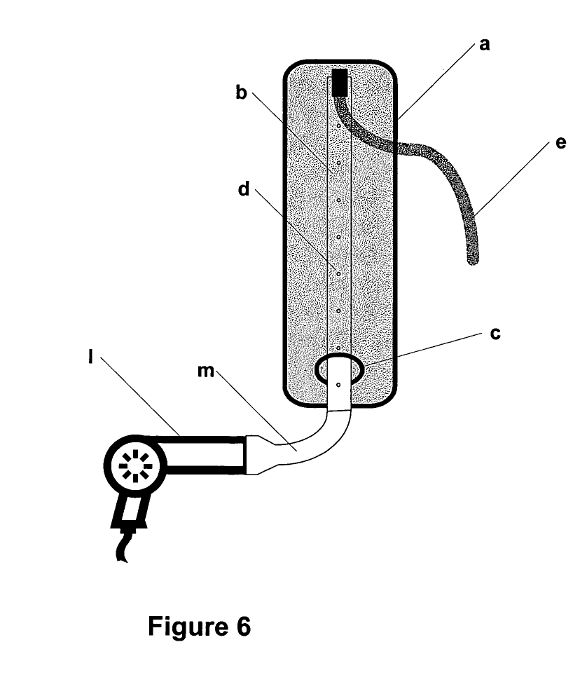

FIG. 6 is another embodiment, where the forced air and heating of the air are both provided by a common hair dryer (l). The hair dryer (l) would be connected to the drying tube (d) via a connector (m), so that drying tube (d) would be able feed the air in the correct direction to dry the bladder (a).

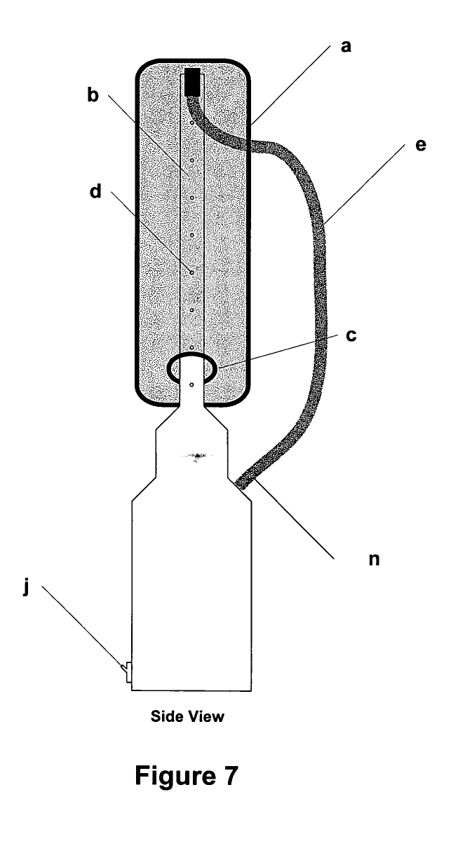

FIG. 7 shows the original embodiment (FIG. 1) with an alternative method of drying the drinking hose portion of the personal hydration system. In this embodiment, there is a second port (n) that comes out of the dryer, in addition to the previously described drying tube (b). This second port (n), or more aptly termed “hose port” would connect straight to the end of the hose (e), and force air up the hose into the bladder (a). This moist air from the hose would then mix with the moist air from the bladder, and it would all be evacuated out of the bladder filling port (c). In this way, the orientation of the personal hydration system over the drying tube (b) is irrelevant.

What is claimed is:

1. A drying system comprised of:
a. A air conduit or tube;
b. A air movement system;
c. A heating unit;
d. Power for the system.

2. The drying system according to claim 1, wherein:
a. The air conduit is of a diameter to fit inside of bladder-style water containment bag(s).
b. The air conduit has holes that direct and channel the airflow to certain areas of the bladder(s), and into the drinking hose of the bladder(s).

3. The drying system according to claim 1, wherein:
a. The air conduit is of a diameter to fit inside of bladder-style water containment bag(s).
b. The air conduit has holes that direct and channel the airflow to certain areas of the bladder(s).
c. A second air conduit directs air into the drinking hose(s)

4. The drying system according to claim 1, wherein:
a. The air movement system could be (but is not limited to) mechanical, electrical or pressured (compressed gas) in nature.

5. The drying system according to claim 1, wherein:
a. The heating unit, placed in the air stream, heats the air to speed up drying of the bladder.

6. The drying system according to claim 1, wherein:
a. Power if needed, can be supplied via DC, AC, or battery.

7. A method for removing moisture from a bladder style water container where air is directed into the bladder(s) via an air conduit(s).

8. The method according to claim 5, wherein the air is introduced into the bladder(s) either by mechanical force or by pressure.
